(19) United States
(12) Patent Application Publication
(10) Pub. No.: US 2024/0028996 A1
(43) Pub. Date: Jan. 25, 2024

(54) ROOT CAUSE ANALYSIS IN PROCESS MINING

(71) Applicant: Microsoft Technology Licensing, LLC, Redmond, WA (US)

(72) Inventors: Mohammadreza FANI SANI, Copenhagen (DK); Michal Adam SROKA, Birkerød (DK); Shahab MORADI, San Bruno, CA (US); Alejandro GUTIERREZ MUNOZ, Parkland, FL (US)

(21) Appl. No.: 17/871,731

(22) Filed: Jul. 22, 2022

(51) Int. Cl. G06Q 10/06

(52) U.S. Cl. CPC G06Q 10/0633

(57) ABSTRACT

Methods, systems and computer program products are provided for performing root cause analysis (RCA) in process mining. Root causes of labeled values may be determined and visualized for user interpretation. RCA performance may be improved by selecting and/or excluding features based on at least one of correlation, granularity, and/or relevance thresholds. An RCA engine may perform RCA on a set of features to generate a set of RCA rules. A visualizer may generate a visualization of the RCA rules. Visualizations may be interactive. For example, users may select a condition to view actions triggered by the condition. Rules may be developed by modifying feature values (e.g., using LIME, SHAP). Users may provide target goals to improve a process, for example, before and/or after visualization. The RCA engine may perform an RCA based on modified feature values to achieve the target goal and present (e.g., visualize) target modifications.

### BACKGROUND

Process mining pertains to data science and process management, where process event logs are mined for event data, which is analyzed to identify problems and improve processes. Process mining tools may perform correlation analyses among features. For example, a business may seek to understand delays in a process. A fundamental problem may be too many steps in the process. A correlation analysis may provide insight into such causation.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Methods, systems and computer program products are provided for performing root cause analysis in process mining. Root causes of labeled values are determined and visualized for user interpretation. The performance of root cause analysis (RCA) may be improved, for example, by selecting and/or excluding features based on at least one of correlation, granularity, and/or relevance thresholds. An RCA engine performs RCA on a set of features to generate a set of RCA rules (e.g., actions triggered by conditions). A visualizer generates a visualization of the RCA rules. Visualizations may be interactive. For example, users may select a condition to view actions triggered by the condition. Rules may be developed by modifying feature values (e.g., using Local Interpretable Model-agnostic Explanations (LIME), SHapley Additive exPlanations (SHAP)). Users may provide target goals to improve a process, for example, before and/or after visualization. The RCA engine may perform an RCA based on modified feature values to achieve the target goal and present (e.g., visualize) target modifications.

Further features and advantages of the subject matter (e.g., examples) disclosed herein, as well as the structure and operation of various embodiments, are described in detail below with reference to the accompanying drawings. It is noted that the present subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an RCA process mining system configured to perform an RCA mining process, according to an example embodiment.

FIG. 2 shows a process for performing RCA process mining and presenting results to users (e.g., process analysts), according to an embodiment.

FIG. 3 shows an example of a visualization of conditions (e.g., subgroups), according to an embodiment.

FIG. 4 shows an example of a visualization of actions discovered (e.g., and selected) for a condition, according to an embodiment.

FIG. 5 shows a flowchart of a method for performing root cause analysis in process mining, according to an example embodiment.

FIG. 6 shows a block diagram of an example computing device that may be used to implement embodiments.

The features and advantages of the examples disclosed will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the various examples. The scope of the present subject matter is not limited to the disclosed embodiments. The disclosed embodiments merely exemplify the various examples, and modified versions of the disclosed embodiments are also encompassed by the present subject matter. Embodiments of the present subject matter are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

If the performance of an operation is described herein as being “based on” one or more factors, it is to be understood that the performance of the operation may be based solely on such factor(s) or may be based on such factor(s) along with one or more additional factors. Thus, as used herein, the term “based on” should be understood to be equivalent to the term “based at least on.” If the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

Process mining pertains to data science and process management, where process event logs are mined for event data, which is analyzed to identify problems and improve processes. Process mining tools may perform correlation analyses among features (variable data elements). Correlation analyses may be faulty and/or may not provide useful insight. For example, a business may seek to understand delays in a process. A fundamental problem with the process may be too many steps. A correlation analysis may not provide meaningful insight into causation for a labeled output (e.g., delay) beyond the obvious that there are too many steps in every implementation of the process.

Methods, systems and computer program products are provided for performing root cause analysis in process mining, which overcome issues in conventional process mining. Root causes of labeled values may be determined and visualized for user interpretation. The performance of root cause analysis (RCA) may be improved, for example, by selecting and/or excluding features based on at least one of correlation, granularity, and/or relevance thresholds. An RCA engine may perform RCA on a set of features to generate a set of RCA rules (e.g., actions triggered by conditions). A visualizer may generate a visualization of the RCA rules. Visualizations may be interactive. For example, users may select a condition to view actions triggered by the condition. Rules may be developed by modifying feature values (e.g., using Local Interpretable Model-agnostic Explanations (LIME), SHapley Additive exPlanations (SHAP)). Users may provide target goals to improve a process, for example, before and/or after visualization. The RCA engine may perform an RCA based on modified feature values to achieve the target goal and present (e.g., visualize) target modifications.

In embodiments, analysis may be performed on processes (e.g., tasks, workflows) to determine which processes and resources are best suited for the task. Looking beyond the aggregate data for various resources may identify circumstances that alter process data. For example, if all processes that have an excessive delay share a specific attribute, the processes with the attribute(s) can be removed from the data as outliers and/or analyzed (e.g., independently) to find an appropriate process for handling them more efficiently.

Root cause analysis (RCA) may be used (e.g., instead of correlation analysis) in process mining to detect the cause(s) of issues/problems in processes with stored records of events (e.g., event logs, Web logs or Web traffic) for one or more sequences of activity in one or more processes (e.g., in any domain, such as healthcare, banking, insurance, education, government, information systems). A web log may be a sequence of activity/events, such as clicks and/or data entry, by a user engaging with a process on a website. In an example, an insurance company process to provide insurance policies may take too much time. RCA may be used to determine why the process is so slow. Event records for empirical insurance policy cases may be categorized and labeled regarding delays to form data sets for an RCA model. An RCA model (e.g., supervised or unsupervised model) may be used to determine the causes of the delays.

An RCA procedure may use visualize RCA rules by performing subgroup discovery and/or tree based methods. For example, an RCA procedure may mine rules before applying RCA rule selection. Multiple rules (e.g., multiple conditions) may provide better results than a single rule (e.g., a single condition). Rules may be made understandable for users, for example, by visualizing the rules.

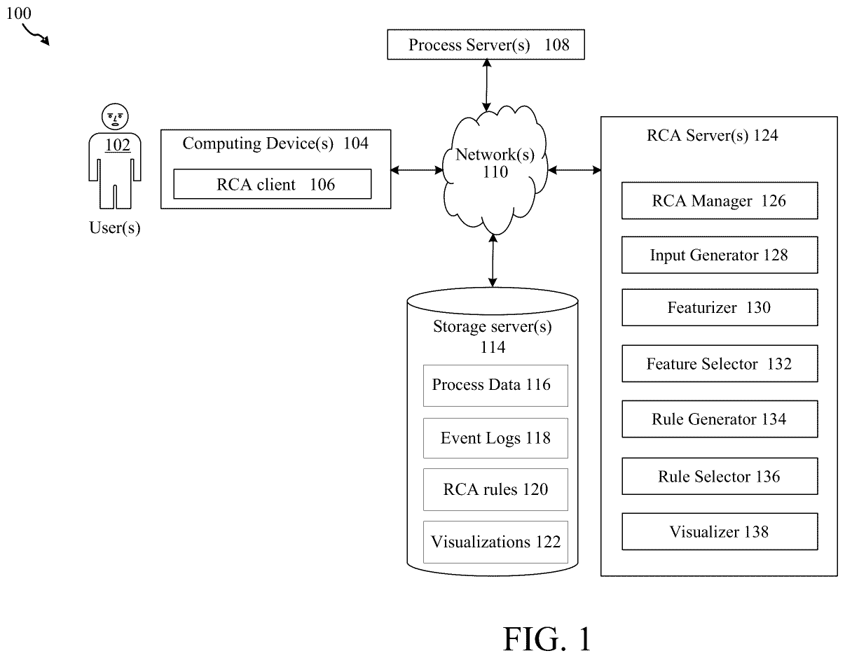

Such embodiments may be implemented in various configurations. For instance, FIG. 1 shows a block diagram of an example of an RCA computing environment (referred to herein as “RCA computing environment”), according to an example embodiment. FIG. 1 shows a block diagram of an example of an RCA process mining system configured to perform an RCA mining process, according to embodiments. For example, process information (e.g., event logs generated or gathered for process mining analysis) may be analyzed in environment 100 to determine RCA predictions for the underlying process(es). RCA computing environment 100 may include, for example, one or more computing devices 104, one or more process servers 108, one or more networks 110, one or more storage servers 114, and one or more RCA servers 124. Each of computing device(s) 104 includes an RCE client 106. Each of RCE server(s) 124 includes an RCE manager 126, an input generator 128, a featurizer 130, a feature selector 132, a rule generator 136, and a visualizer 138. In further embodiments, a server may include fewer than each of the components shown in FIG. 1 for RCA server(s) 124. Example RCA computing environment 100 presents one of many possible examples of computing environments. Example RCA computing environment 100 may comprise any number of computing devices, process servers, storage servers, and/or RCA servers, such as example components illustrated in FIG. 1 and other additional or alternative devices not expressly illustrated. The components of environment 100 are further described as follows.

Network(s) 110 may include, for example, one or more of any of a local area network (LAN), a wide area network (WAN), a personal area network (PAN), a combination of communication networks, such as the Internet, and/or a virtual network. In example implementations, computing device(s) 104, process server(s) 108, storage server(s) 114, and RCA server(s) 124 may be communicatively coupled via network(s) 110. In an implementation, any one or more of computing device(s) 104, process server(s) 108, storage server(s) 114, and RCA server(s) 124 may communicate via one or more application programming interfaces (APIs), and/or according to other interfaces and/or techniques. Computing device(s) 104, process server(s) 108, storage server(s) 114, and RCA server(s) 124 may include one or more network interfaces that enable communications between devices. Examples of such a network interface, wired or wireless, may include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

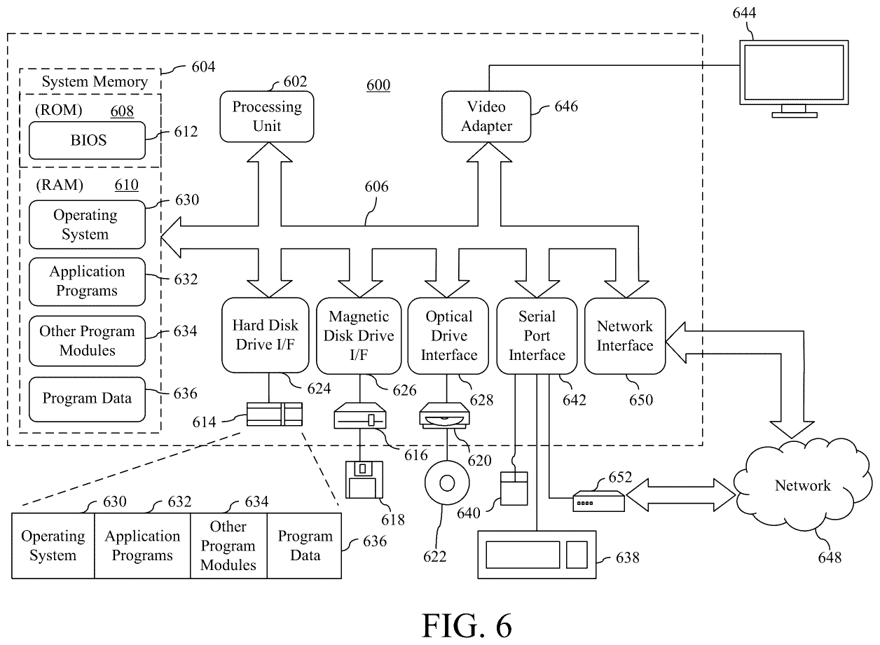

Computing device(s) 104 may comprise computing devices utilized by one or more users (e.g., individual users, family users, enterprise users, governmental users, administrators, hackers, etc.) generally referenced as user(s) 102. Computing device(s) 104 may comprise one or more applications, operating systems, virtual machines (VMs), storage devices, etc., that may be executed, hosted, and/or stored therein or via one or more other computing devices via network(s) 110. In an example, computing device(s) 104 may access one or more server devices, such as process server(s) 108, storage server(s) 114, and RCA server(s) 124, to provide information, request one or more services (e.g., content such as process data, RCA analysis) and/or receive one or more results (e.g., RCA rule visualizations). Computing device(s) 104 may represent any number of computing devices and any number and type of groups (e.g., various users among multiple cloud service tenants). User(s) 102 may represent any number of persons authorized to access one or more computing resources. Computing device(s) 104 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing device(s) 104 are not limited to physical machines, but may include other types of machines or nodes, such as a virtual machine, that are executed in physical machines. Computing device(s) 104 may each interface with process server(s) 108, storage server(s) 114, and RCA server(s) 124, for example, through APIs and/or by other mechanisms. Any number of program interfaces may coexist on computing device(s) 104. An example computing device with example features is presented in FIG. 6.

Computing device(s) 104 have respective computing environments. Computing device(s) 104 may execute one or more processes in their respective computing environments. A process is any type of executable (e.g., binary, program, application) that can be, is being, or was executed by a computing device. A computing environment may be any computing environment (e.g., any combination of hardware, software and firmware). For example, computing device(s) 104 may execute RCA client 106, which may provide a user interface (e.g., a graphical user interface (GUI)) for user(s) 102 to interact with. RCA client 106 may be configured to communicate (e.g., via network(s) 110) with one or more applications executed by RCA server(s) 124, such as RCA manager 126.

User(s) 102 may interact with RCA client(s) 106 to manage jobs. For example, a user 102 may use RCA client 106 to develop (e.g., via a process mining (PM) job editor) and/or to submit prospective PM jobs to RCA server(s) 124 for root cause analysis (e.g., including predictions, such as RCA rules and/or visualizations of RCA rules). User(s) 102 and/or other sources may submit jobs to process server(s) 108 for execution, which may result in process data that may be stored (e.g., by storage server(s) 114, mined and analyzed (e.g., to determine potential improvements in processes). RCA jobs may be entered by user(s) 102, e.g., using RCA client 106. An RCA job may indicate a dataset (e.g., a mined dataset or a link to data), to return a result (e.g., one or more RCA rules, which may be visualized).

An RCA job may be submitted for analysis, for example, from RCA client 106 executed by computing device(s) 104 to RCA manager 126 executed by RCA server(s) 124. A processing job to be scheduled for execution may be submitted, for example, from RCA client 106 executed by computing device(s) 104 to runtime server(s) 108.

User(s) 102 may use RCA client 106 to access (e.g., view, collect) job execution information (e.g., process data 116) generated by process server(s) 108 and/or prediction information (e.g., event log 118, RCA rules 120, visualizations 122) generated by RCA server(s) 124. In some examples, RCA client 106 may be a Web application executed by RCA server(s) 124, in which case RCA client 106 on computing device(s) 104 may represent a Web browser accessing RCA client 106 executed by RCA server(s) 124.

Process server(s) 108 may comprise one or more computing devices, servers, services, local processes, remote machines, web services, etc. for executing jobs, which may be received from computing device(s) 104 and/or other devices. In an example, process server(s) 108 may comprise a server located on an organization's premises and/or coupled to an organization's local network, a remotely located server, a cloud-based server (e.g., one or more servers in a distributed manner), or any other device or service that may host, manage, and/or provide resource(s) for execution service(s) for processing jobs. Process server(s) 108 may be implemented as a plurality of programs executed by one or more computing devices.

In an example, process server(s) 108 may comprise an exabyte-scale big data platform with hundreds of thousands of machines operating in multiple data centers worldwide. A runtime server system may use a resource manager, for example to manage hundreds of thousands or millions of system processes per day from tens of thousands of users. A runtime server system may manage efficiency, security, scalability and reliability, utilization, balancing, failures, etc.

Storage server(s) 114 may comprise one or more storage devices. Storage server(s) 114 may store data and/or programs (e.g. information). Data may be stored in storage server(s) 114 in any format, including tables. Storage server(s) 114 may comprise, for example, an in-memory data structure store. Storage server(s) 114 may represent an accumulation of storage in multiple servers. In some examples, storage server(s) 114 may store process data 116, resource information (info) 118, RCA rules 120, and/or visualizations 122. Storage server(s) 114 may be accessed by or through computing device(s) 104, process server(s) 108, and/or RCA server(s) 124, e.g., to read and/or write information (e.g., process data 116, event logs 118, RCA rules 120, visualizations 122).

Process data 116 may include data pertaining to processes, for example, during execution. Process data 116 may be generated by process servers (e.g., process server(s) 108) in one or more data centers. Process data 116 may be stored in one or more storage devices in one or more locations managed by one or more storage servers (e.g., storage server(s) 114). Process data may include, for example, one or more of the following: a process ID, a date, a type of activity or function performed, a resource cost, resources used, location of resources, user information, etc.

Event log 118 may include information about one or more processes executed by process server(s) 108. Event log 118 may be generated from process data 116. Event log 118 may arrange data in one or more formats expected by featurizer 130. RCA client 106 and/or input generator 128 may generate event logs 118 from process data 116.

RCA rules 120 may be predicted by rule generator 134, which may be referred to as an RCA engine. RCA rules 120 may include one or more RCA rules generated by rule generator 134 and/or selected by rule selector 136.

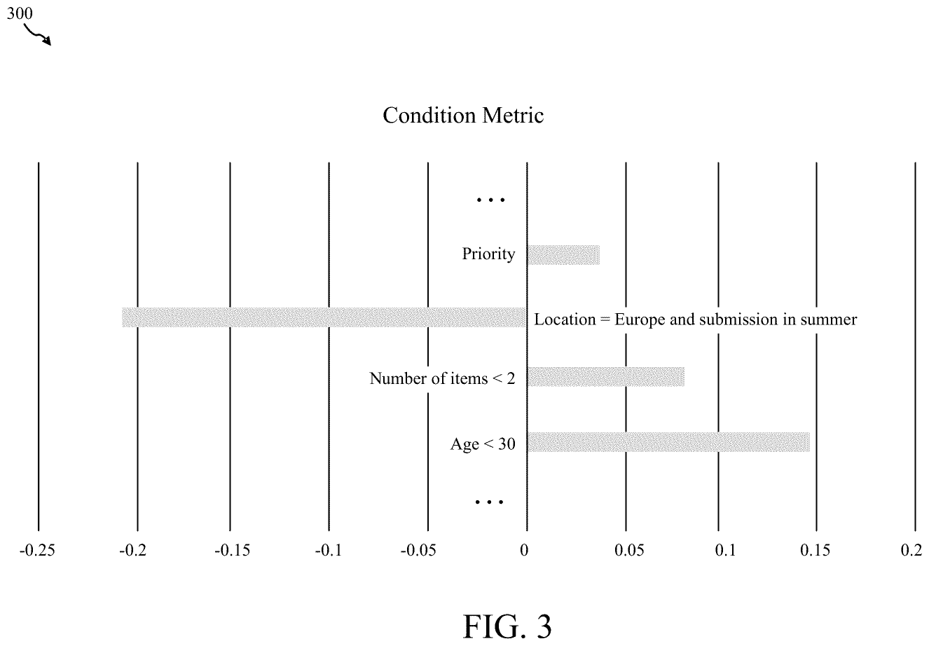

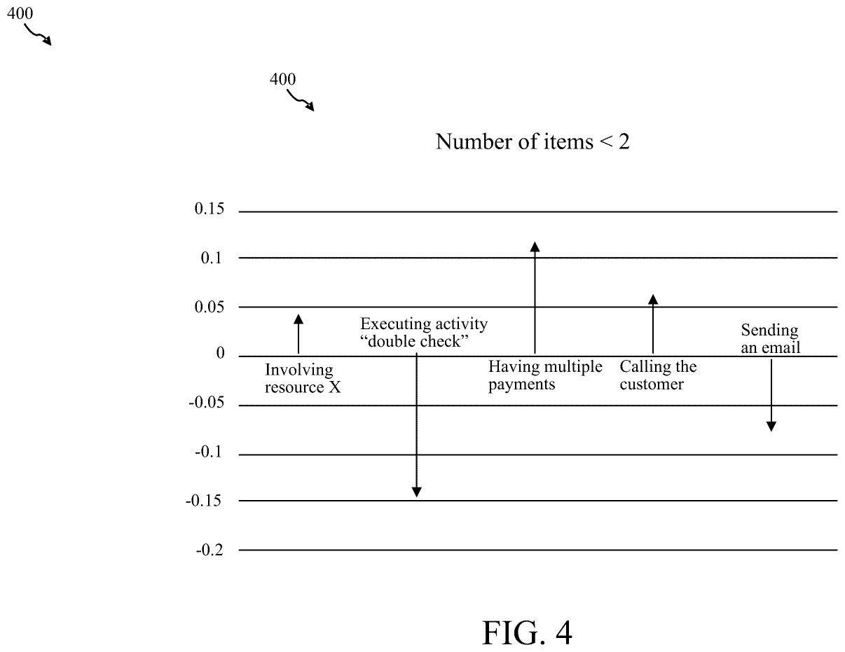

Visualizations 122 may be generated by visualizer 138. Visualizations 122 may visualize RCA rules 120 selected by rule selector 136. FIGS. 3 and 4 show example visualizations of conditions and actions for a condition, respectively.

RCA server(s) 124 may comprise one or more computing devices, servers, services, local processes, remote machines, web services, etc. for providing runtime distribution prediction-related service(s) for prospective (e.g., proposed) jobs, which may be received from computing device(s) 104. In an example, RCA server(s) 124 may comprise a server located on an organization's premises and/or coupled to an organization's local network, a remotely located server, a cloud-based server (e.g., one or more servers in a distributed manner), or any other device or service that may host, manage, and/or provide prediction-related service(s) for prospective (e.g., proposed) jobs. RCA server(s) 124 may be implemented as one or more (e.g., a plurality of) programs executed by one or more computing devices. Prediction server programs or components thereof may be distinguished by logic or functionality (e.g., as shown by example components in FIG. 1). In some examples, RCA server(s) 124 may include a machine learning (ML) model, which may be executed by one or more (e.g., backend) computing systems. All or a portion of RCA server(s) 124 may be executed on cloud server(s), on-premises server(s), and/or client-machine(s), such as computing device(s) 104.

RCA server(s) 124 may be configured to characterize and predict runtime variation based on the distribution of normalized runtimes of recurring jobs. RCA server(s) 124 may be configured with a machine learning (ML) model. A trained ML model may include one or more components and one or more operations that take input data and return one or more predictions. Multiple components shown in RCA server(s) 124 may comprise one or more ML models.

RCA server(s) 124 may utilize information at the job level and the machine level (e.g., job data 116, resource info 118) to generate runtime distribution predictions.

RCA server(s) 124 may (e.g., each) include one or more job runtime distribution prediction components, such as, for example, RCA manager 126, featurizer 130, feature selector 132, trainer(s) 132, Rule generator 134, visualizer 138, and/or discoverer 136, which together may form one or more ML models.

RCA manager 126 may (e.g., be configured to) may manage RCA input, RCA processes and RCA results. RCA manager 126 may provide RCA client 106. RCA manager 126 may provide an interface between (e.g., and communicate with) computing device(s) 104 (e.g., RCA client 106), storage server(s) 114 and other RCA components in RCA server(s) 124. For example, RCA manager 126 may manage user interfaces (e.g., RCA client 106), data collection (e.g., process data 116) and input data (e.g., event logs 118) generation (e.g., by input generator 128), RCA scheduling and execution/analysis by an RCA engine (e.g., rule generator 134), information storage (e.g., RCA rules 120 and visualizations 122), RCA model training, etc. In some examples, RCA manager 126 may receive (e.g., from RCA client 106) process data 116, a link to process data 116, process information, etc. RCA manager 126 may provide the information received to input generator 128.

Input generator 128 may generate event logs 118 from process data 116, for example, based on information received from RCA manager 126. User(s) 102 may use root cause analysis (RCA) client 106 running on computing device(s) 104 to communicate with RCA server(s) 124. For example, RCA client 104 may indicate a process for evaluation by RCA server(s) 124. In some examples, user(s) 102 may provide a file (e.g., in tabular format) or a connector (e.g., a link) to process information (e.g., process data 116) in an information system (e.g., storage 114). Input generator 128 may perform operations to collect and format process data 116, which may be scattered among data centers, mixed among process data for other processes. Event logs 118 generated by input generator 128 may be stored by storage server(s) 114, e.g., for access by featurizer 130. Input generator 128 may represent a combination of multiple data preparation (prep) components/functions, such as, for example, a data filter/selector, data loader/extractor, data preprocessor (e.g., data transformer, data normalizer), etc.

In an example, a user may provide a connector. Input generator 128 may generate corresponding tabular data for an RCA process analysis. Input generation (e.g., creation of a process event log) may be automated, for example, using an enterprise resource planning (ERP) system. In an example, an event log may include multiple columns, such as an identifier (ID) for a process instance, an activity performed, an execution time of the activity, etc. (e.g., including other columns that may be specific to the process and/or activities performed by the process). A (e.g., each) process instance may have several activities. A (e.g., each) row may correspond to a (e.g., one) process instance. An event log (e.g., or other RCA input) may include other fields (e.g., columns), which may relate to the rows and/or the process instances. In an example, a process instance identifier may be a customer identifier (ID for an insurance ID, a patient ID, or a student ID. In some examples, there may be one or more columns representing one or more steps in a sequence of steps/activities for a process (e.g., to apply for insurance). In some examples, there may be an indication of an order of activities, such as step 10 of 59 steps or a timestamp (e.g., for the occurrence of an event in a respective process). Other fields in an input data set may include, for example, customer name, age, etc. In some examples, input data in an event log may be created, provided, or selected by a user.

Table 1 shows an example of an event log generated by input generator 108 or provided by user(s) 102, e.g., via RCA client 106.

TABLE 1
Example of a process event log for RCA evaluation

| | | | Customer | | | | |
|---|---|---|---|---|---|---|---|
| Process | | | requested | Resource | | | |
| ID | Activity | Date | credit | Cost | Resource | Location | Age |
| 1001 | Submit | 2020 Oct. 23 | 1,000,000 | 0 | User002 | Germany | 37 |
| | Documents | | | | | | |
| 1001 | Call for help | 2020 Oct. 25 | 1,000,000 | 2,500 | Res15 | Germany | 37 |
| 1002 | Submit | 2020 Oct. 25 | 700,000 | 0 | User003 | France | 21 |
| | Documents | | | | | | |
| 1001 | Withdraw | 2020 Oct. 28 | 1,000,000 | 7,300 | User002 | Germany | 37 |
| | the request | | | | | | |
| 1002 | Apply for | 2020 Nov. 3 | 700,000 | 3,500 | Res1 | France | 21 |
| | credit scoring | | | | | | |
| 1003 | Submit | 2020 Nov. 4 | 1,200,000 | 0 | User004 | USA | 73 |
| | Documents | | | | | | |
| 1002 | Add | 2020 Nov. 8 | 700,000 | 500 | Res7 | France | 21 |
| | additional | | | | | | |
| | information | | | | | | |
| . . . | . . . | . . . | . . . | . . . | . . . | . . . | . . . |

Featurizer 130 may (e.g., be configured to) generate features based on event logs 118 and/or other information about the process to be analyzed/processed by the RCA engine (e.g., rule generator 134). Featurizer 130 may access event logs 118. Featurizer 130 may generate key performance indicators (KPIs). In some examples, user(s) 102 may provide one or more KPI(s). In some examples, user(s) 102 may customize features generated by featurizer 130. Featurizer 130 may represent a combination of multiple data preparation (prep) components/functions, such as, for example, a data filter/selector, data loader/extractor, data preprocessor (e.g., data transformer, data normalizer), feature extractor, feature preprocessor (e.g., feature vectorizer), etc.

Featurizer 130 may generate (e.g., output) a data table with features. Featurizer 130 may featurize (e.g., extract, process, arrange) data from event logs 118, for example, based on the type of process, the type of data, the type of RCA analysis, the type of output (e.g., labeled data). Featurizer may extract process mining and data related features of process instances from an event log. A feature table may (e.g., unlike an event log) present each process instance (e.g., process ID) in a column of a feature table. A (e.g., each) row in a feature table correspond to a process instance.

Featurizer 130 may generate classification attributes, such as, performance based attributes (e.g., successful/unsuccessful), time, resource cost, status (e.g., complete/incomplete), etc. Featurizer 130 may add features, such as process model related features. For example, a process model may be discovered (e.g., in the background) or received (e.g., from user(s) 102). A process model may be used to add zero or more features to a (e.g., each) process instance. For example, a process model may add a feature indicating whether a process instance deviates from the process model (e.g., aligned or misaligned with the model), whether a process instance passed selected points, etc. A process model may be discovered, for example, by using one or more process discovery algorithms, such as Inductive Miner, Split Miner, Fuzzy Miner, etc.

Table 2 shows an example of a feature table generated by featurizer 130.

TABLE 2
Example of a process feature table for RCA evaluation

| | | | Customer | | | | | |
|---|---|---|---|---|---|---|---|---|
| Process | | Start | requested | Variant | | | | |
| ID | Start | Date | credit | Freq | Dev | Time | Status | Cost |
| 1001 | Submit | 2020 Oct. 23 | 1,000,000 | 750 | Y | 5 | complete | 9800 |
| | Docs | | | | | days | | |
| 1002 | Submit | 2020 Oct. 25 | 700,000 | 180 | N | 27 | Incomplete | 14800 |
| | Docs | | | | | days | | |
| 1003 | Submit | 2020 Nov. 4 | 1,200,000 | 680 | Y | 4 | Complete | 5700 |
| | Docs | | | | | days | | |
| 1004 | Redirect | 2020 Nov. 12 | 450,000 | 23 | Y | 3 | Incomplete | 2400 |
| | other | | | | | days | | |
| | process | | | | | | | |
| . . . | . . . | . . . | . . . | . . . | . . . | . . . | . . . | . . . |

A feature table may be labeled. Labeling may be automated or manual. In some examples, featurizer 130 may label a feature table. A feature table may have one or more labels.

One or more columns in a feature table may be labeled. In some examples, an expression over multiple columns may be selected as a labeled column. Threshold values may be determined (e.g., and/or provided) for numerical values. For example, a threshold may identify/indicate a number of events per process instance, or time (e.g., throughput time) for a process. In some examples, one or more categorical features may be determined (e.g., or indicated) for a label. A formula and/or additional features may be determined (e.g., or identified). For example, a formula, features, and/or labels may be determined or user-defined. For example, user(s) 102 may convert time (e.g., throughput time) to a categorical feature indicated as “Delay” and “Normal.” As another example, a label feature may be the result of a computation. For example, cost, requested credit, and time features may be used in the computation of a label feature that indicates whether the cost of each process instance is high or normal for the company. Table 3 shows an example of a labeled feature table for RCA evaluation.

TABLE 3
Example of a labeled feature table for RCA evaluation

| | | | Customer | | | | | | |
|---|---|---|---|---|---|---|---|---|---|
| Process | | Start | requested | Variant | | | | | |
| ID | Start | Date | credit | Freq | Dev | Time | Status | Cost | Label |
| 1001 | Submit | 2020 Oct. 23 | 1,000,000 | 750 | Y | 5 | complete | 9800 | High |
| | Docs | | | | | days | | | cost |
| 1002 | Submit | 2020 Oct. 25 | 700,000 | 180 | N | 27 | Incomplete | 14800 | High |
| | Docs | | | | | days | | | cost |
| 1003 | Submit | 2020 Nov. 4 | 1,200,000 | 680 | Y | 4 | Complete | 5700 | High |
| | Docs | | | | | days | | | cost |
| 1004 | Redirect | 2020 Nov. 12 | 450,000 | 23 | Y | 3 | Incomplete | 2400 | Norm |
| | other | | | | | days | | | cost |
| | process | | | | | | | | |
| . . . | . . . | . . . | . . . | . . . | . . . | . . . | . . . | . . . | |

Feature selector 132 may (e.g., be configured to) select (e.g., from among) features generated by featurizer 130. In some examples, feature selector 132 may select a subset of a set of features generated by featurizer 130. Fewer features may improve the performance of RCA (e.g., RCA rules 120) for data mined process analyses. Feature selector 132 may receive or access as input a labeled feature table and generate/output a selected labeled feature table.

Some features may be useless to detrimental in an RCA process mining analysis. For example, a process ID feature may be useless in an RCA process mining analysis. As another example, a process instance time (e.g., throughput time) feature may be too correlated for an analysis classifying root causes of classifications labels process time Delay/Normal. An RCA machine learning method may (e.g., otherwise) indicate throughput time has the highest impact on classifications labels process time Delay/Normal, reducing the insight value of RCA results. Feature selector 132 may preprocess features to trim features (e.g., select, unselect/remove features).

In some examples, feature selector 132 may consider a one-to-one relationship between each feature in a labeled feature table to the labeled feature (e.g., and the cardinality of categorical features) to determine whether to include each feature in a selected labeled feature table, for example, to improve RCA performance. In some examples, feature selector 132 may not remove features. Rather, feature selector 132 may indicate to rule generator 134 which features to utilize in an RCA. User(s) 102 may be able to see which features are selected/deselected. In some examples, users may select/deselect features. In an example of a labeled feature table with n features, the whole search space of combined features may be 2′. An RCA procedure (e.g., implemented by an RCA engine) to generate RCA rules may be completed faster with higher accuracy and/or insightfulness based on feature selection by feature selector 132.

In some examples, each (e.g., selected) feature may be categorized as one of process-related (P) or instance-related (I). Process-related features may be related to actions that are performed during a process. Instance-related features may be related to each process instance. Examples of instance-related features (I) include, for example, one or more of the following: product type, requested amount, location of customer, etc. Examples of process-related features (P) may include, for example, one or more of the following: waiting time of a first manual activity, a corresponding resource (e.g., employee), a number of active instances, a number of self-loops for the instance, etc.

Feature selector 132 may determine/detect whether a feature is instance-related or process-related, for example, by considering the cardinality of data attributes. Feature selector 132 may detect an attribute is a case attribute, for example, if the value is similar for all the events of a process instance. A case attribute may be determined to be an instance-related feature. Case attributes that are added may (e.g., also) be considered as process-based attributes. Different tables may be used, for example, if an event log is generated from a connector. The category of each feature may be selected and/or indicated/provided. A user may be permitted to change the categories of features. Insight may be provided by instance-based features. For example, there may be a delay for specific customers/products that may not be changed. The attributes may be used for descriptive analysis and correlation analysis, e.g., as opposed to an RCA analysis intended for process improvement. An RCA may identify resources or a sequence of activities in a process that may be changed, for example, to improve the process.

Table 4 shows an example of features selected/deselected by feature selector 132. A checkmarks (✓) indicates a feature is selected. Process-related features are indicated by “P.” Instance-related features are indicated by “I.”

TABLE 4
Example of features selected from available features for RCA

| | | ✓ | P | ✓ | | | | | |
|---|---|---|---|---|---|---|---|---|---|
| I | ✓ | I | Customer | P | | ✓ | ✓ | | |
| Process | P | Start | requested | Variant | P | P | P | P | |
| ID | Start | Date | credit | Freq | Dev | Time | Status | Cost | Label |
| 1001 | Submit | 2020 Oct. 23 | 1,000,000 | 750 | Y | 5 | complete | 9800 | High |
| | Docs | | | | | days | | | cost |
| 1002 | Submit | 2020 Oct. 25 | 700,000 | 180 | N | 27 | Incomplete | 14800 | High |
| | Docs | | | | | days | | | cost |
| 1003 | Submit | 2020 Nov. 4 | 1,200,000 | 680 | Y | 4 | Complete | 5700 | High |
| | Docs | | | | | days | | | cost |
| 1004 | Redirect | 2020 Nov. 12 | 450,000 | 23 | Y | 3 | Incomplete | 2400 | Norm |
| | other | | | | | days | | | cost |
| | process | | | | | | | | |
| . . . | . . . | . . . | . . . | . . . | . . . | . . . | . . . | . . . | |

Rule generator 134 may determine one or more RCA rules. Rule generator 134 may receive as input an indication of selected features and labeled data (e.g., in a selected, labeled feature table). Rule generator 134 may classify features according to the labeled data. Rule generator 134 may generate (e.g., output) one or more (e.g., a set of) RCA rules indicating the root cause(s) of the labeled data. Root causes of labeled classes (e.g., long delay) may be defined by rules. A rule may be an action triggered by a condition.

Root cause (e.g., causal rules) are different from correlation. Examples of correlation may include, for example, (i) delays for most patients that come to a hospital on weekends; (ii) most Invoices that have currencies other than USD are delayed; and/or (iii) most papers with an author from country X or Y will be rejected. The term “most” in the above correlations may be presented with a value (e.g., a confidence level).

In contrast to correlation, causal rules (e.g., RCA rules) may have three components, e.g., a label value, a condition, and an action. A label (e.g., classification labels to be predicted by an ML model) may be generated/determined and/or indicated (e.g., by user(s) 102). Conditions may be computed based on instance-based attributes. Actions may be computed based on process-based attributes and may by considering counterfactuals for each condition and the corresponding metric(s) (e.g., uplift value).

Insightful (e.g., valuable) conditions may be determined, for example, using subgroup discovery techniques. Actions may be determined for a (e.g., each) condition. For example, actions with the highest positive/negative impact may be determined. In an example, rule generator 134 may receive a preselected, labeled feature table. Rule generator may discover conditions (e.g., perform condition discovery) based on the preselected, labeled feature table, for example, using subgroup discovery. Rule generator 134 may discover actions (e.g., perform action discovery), for example, using one or more techniques, such as tree-based decision methods (e.g., uplift trees, Local Interpretable Model-agnostic Explanations (LIME), SHapley Additive exPlanations (SHAP)). Rule generator 134 may generate one or more (e.g., a set of) RCA rules 120 (e.g., based on the label value(s), the condition(s) and the action(s).

Subgroup discovery performed by rule generator 134 may determine one or more conditions that are valuable for analysis. A valuable/insightful condition may have high support (e.g., high proportion of all instances have an occurrence of the condition). A valuable/insightful condition may have a different distribution of target value compared to all data. One or more metrics and techniques may be used to determine conditions. Multiple (e.g., instance-based) attributes may be considered.

One or more conditions may be selected from discovered/determined conditions. For example, the K top conditions may be selected. In some examples, conditions may be selected based on one or more thresholds (e.g., all conditions with a value higher than a threshold may be used). The absolute value of a range of a metric may be used to select conditions, for example, if a range of values of the metric include negative values. Examples of conditions may include, for example, one or more of the following conditions shown as first and second conditions C1, C2:
C1: (customer=company 1 & start_on_weekend=True)→Delay (metric 0.115)
C2: (product=P23)→Expensive (metric −0.2)

One or more actions may be determined for each determined or selected condition. Action discovery may perform prospective or “What If” scenario discovery and presentation. Actions may be determined using one or more machine learning methods. An ML method (e.g., the core of an ML method) may be interpretable. Interpretable ML methods may include, for example, one or more of the following: tree-based methods, LIME, and/or SHAP. One or more metrics may be used to select and/or order discovered actions for each condition. For example, an uplift value may be used to order discovered actions. In some examples, process-based features may be used to discover and/or order actions. Examples of actions may include, for example, one or more of the following shown as first, second and third actions A1, A2, A3:
A1: involving resource X in the process
A2: waiting time for activity “resend documents” less than 2 days
A3: following specific process variant(s) for a process instance

One or more metrics may be used to evaluate each action (for a given condition). An action may be validated, for example, by considering the instances of the condition with the same label value that have or do not have the action. For example, instances with condition C1 that are delayed may be divided based on whether the action does or does not apply to them. A comparison of these two distributions (e.g., using machine learning methods) or considering the counterfactuals may indicate how an action leads to an impact on a value/class of a labeled/evaluated feature.

The RCA engine (e.g., rule generator 134) may be used to make predictions about hypothetical scenarios, e.g., by performing RCA based on actual feature values and modified feature values. This may provide further insight into process improvement based on the determined RCA rules 120. The results may be presented to user(s) 102 through visualizations 122 for manual or automated decisions about improving a process. For example, rule generator 134 may implement or test and analyze zero or more variations/alternatives (e.g., what-if, potential or modified) in feature sets and/or values (e.g., scenarios) to develop and/or improve zero or more RCA rules that explain the process (e.g., in terms of classification label issues).

Rule selector 136 may select one or more RCA rules generated by rule generator 134. Rule selector 136 may select K top discovered rules based on their metric(s). The K value may be determined based on the display setting of computing device 104. Rule selector 136 may select rules for visualization based on one or more thresholds indicating a threshold impact in order to be visualized. For example, all the rules that have metric(s) value higher than one or more thresholds.

Visualizer 138 may visualize selected RCA rules. Visualizer 138 may (e.g., be configured to) explain/present root causes indicated by RCA rules. An explanation/presentation of RCA rules may include displaying RCA rules to user(s) 102.

Visualizer 138 may receive discovered (and selected) conditions, and actions based on the conditions, which, together, create rules for the labeled classes. Visualizer 138 may provide interpretable visualization of RCA rules. For example, a visualization 122 may show how different values of a feature impact the value(s) of a condition. Visualizer 138 may generate (e.g., and store) visualizations 122. Visualizations 122 may visually present discovered (e.g., and selected) conditions and actions. Visualizations 122 may be provided by RCA manager 126 to RCA client 106 for presentation to user(s) 102 via a graphical user interface. Interpretable visualizations based on root cause analysis may assist user(s) 102 in quickly understanding the real underlying issues and determining useful solutions.

Visualizer 138 may utilize feature contribution algorithms to help users understand various factors associated with process issues/labeled classes, as indicated by rules based on conditions and actions. Visualizer 138 may perform a descriptive analysis, for example, to help users understand the process characteristics that lead to issues/problems identified by labeled classes (e.g., excessive delay). The classification model (e.g., Rule generator 134) and/or other machine learning explanation tools may be used to understand the sources of issues/problems. Visualizer 138 may, for example, quantitatively attribute labeled classes to each of multiple features.

In some examples, visualizer 138 may perform a two-step visualization. In a first step, the discovered (e.g., and selected) conditions (e.g., subgroups) may be presented based on their respective metrics. In an example, a method with a negative and positive range may be visualized in color with two hues (e.g., to distinguish positive and negative impact on performance). Afterwards (in a second step), visualizer 138 may present actions for the condition(s), and user(s) 102 may select one or more actions from the presented actions. In this way, just actions of conditions that are interesting for the user may be presented.

Visualizer 138 may present visualizations of actual and what-if RCA rules, for example, to better demonstrate to user(s) 102 how root causes affect process performance identified by class labels (e.g., normal performance, delayed performance). Visualizations 122 generated by visualizer 138 may provide descriptive analysis of rules. Visualizer 138 may not change the values of the features and attributes used in subgroup discovery. Interpretable visualization may assist user(s) 102 with focusing on insightful conditions that may have business value.

RCA rules may be N-gram rules. RCA rules may include unigram rules, such as when a type is gold the result is fast (e.g., type=gold==>fast). RCA rules may include bigram rules, such as when a type is gold and a resource R1 is used, the result is slow (e.g., type=gold & resource=R1==>slow).

Visualizations 122 generated by visualizer 138 may provide a progressive analysis (e.g., and presentation) of the mined RCA rules to indicate how different attributes impact the causes. Rules may be determined based on process information (e.g., selected features). Identified rules may be further developed or improved and/or additional rules may be developed, for example, by performing what-if analyses and/or goal-seek analyses.

In some examples, visualizations 122 may be interactive for user(s) 102. Visualization interaction may include, for example, what-if and goal-seek analyses. For example, user(s) 102 may review visualizations 122 of causation rules developed by the RCA engine's analysis of (e.g., empirical) process information. User(s) 102 may submit one or more target goals for the process in question. In an example, user(s) 102 may provide a target goal to reduce delayed cases by x%. The RCA system may analyze results, potentially performing an RCA using altered/alternative variables (e.g., alternative and/or additional process feature values) in one or more what-if scenarios, and provide recommended solutions to achieve the target goal. An example of a recommendation may include, for example, increasing the number of resources from two to three machines, automating a manual portion of a process for one or more types/categories of process instances, etc.

Shapley values may be adapted to explain the contribution of features in ML models. Shapley values may explain the quantitative contribution of each feature to one or more root causes. An example method using Shapley values may randomly permute other feature values and evaluate the marginal changes of the predictions. Shapley values may be indicated in visualizations 122, for example, in a waterfall plot showing (e.g., positive and/or negative) contributions of different features.

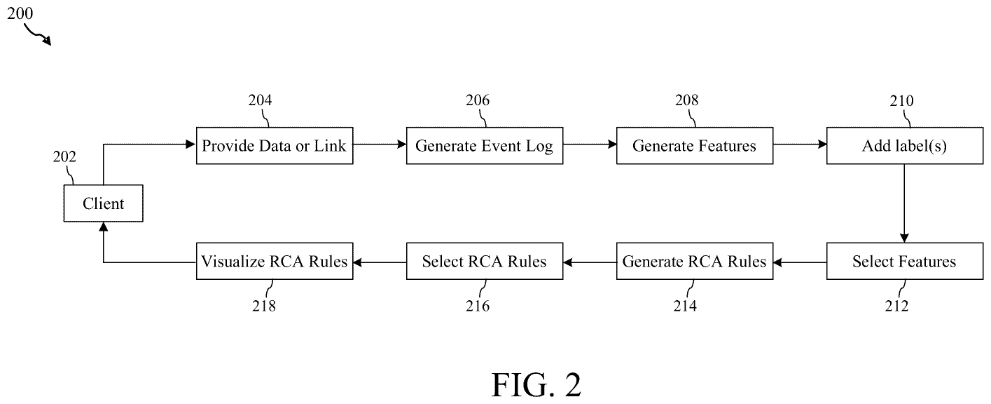

FIG. 2 shows an example of a process for performing RCA process mining and presenting results to users (e.g., process analysts), according to embodiments. Embodiments disclosed herein and other embodiments may operate in accordance with example method 200. Method 200 comprises steps 204-218. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implements all of the steps illustrated in FIG. 2. FIG. 2 is simply one of many possible embodiments. Embodiments may implement fewer, more or different steps. The example shown in FIG. 2 may be interpreted with reference to the example shown in FIG. 1.

As shown in FIG. 2, at step 204, client 202 (e.g., RCA client 106 used by user(s) 202) may provide (e.g., to RCA manager 126) a data or a link to data for a process to analyze.

At step 206, an event log may be generated (e.g., by input generator 128) based on the data or link provided in step 204. An event log may indicate a sequence of activities in a process. Event log generation 206 may generate an event log in an RCA data mining process. An event log (e.g., with or without input data pre-processing) may be an input data set to an RCA mining process model. Input data sets may be configured based on (e.g., according to) an RCA model. In some examples, an input data set for an RCA model (e.g., created from a process event log) may be in a tabular format or an xes format. In some examples, there may be multiple (e.g., at least three) columns of data, such as a process instance identifier (e.g., a customer identifier (ID) for an insurance ID, a patient ID, or a student ID), one or more columns representing one or more steps in a sequence of steps/activities for a process (e.g., to apply for insurance), and an indication of an order of activities such as step 10 of 59 steps or a timestamp (e.g., for the occurrence of an event in a respective process). Other fields in an input data set may include, for example, customer name, age, etc. In some examples, input data in an event log may be created, provided, or selected by a user.

At step 208, features may be generated (e.g., by featurizer 130), for example, in a feature table, based on the event log generated by input generator 128. Feature generation 208 may include pre-processing. Feature generation 208 may generate features (e.g., process mining features, data attribute features) from one or more process event logs. Features may be indicated in a feature table.

At step 210, one or more labels (e.g., classifications) may be added (e.g., automatically by featurizer 130 or manually by user(s) 102) to the feature table. Labeling 210 may create target values or classes in an ML model. Data may be labeled based on thresholds. Thresholds used to determine which label to apply to data may or may not be known to properly label the data. For example, e.g., with regard to an RCA model determining cause for delays, thresholds for delays may be based on a number of days, weeks, etc. For example, a delay may not begin until 20 days after a specified event. One or more default (e.g., generic) thresholds may be selected and applied. For example, reasons for delays in the application of insurance benefits for patients in the medical field may include, for example, claim not filed with insurance, a deceased patient, awaiting approval of benefits, value of insurance claim, etc. Delay thresholds and cause of delay labels may vary among input data. For example, insurance claims may vary based on the amount in question. Larger value cases may receive more review through more departments and naturally take longer.

At step 212, one or more features may be selected (e.g., automatically by featurizer 130 or manually by user(s) 102) from the feature table. Feature selection 212 may select and/or remove features from a feature table. Features may be adjusted (e.g., trimmed) to improve RCA performance. In some examples, a feature selection 212 may (e.g., automatically) select or not select (e.g., remove) features, for example, based on knowledge of a sequence of activities/steps in a process, types of users, time between activities, resources and/or employees involved in a process, data types or categories. For example, feature selection 212 may eliminate, discard (e.g., not select) data (e.g., columns) in input data (e.g., event log(s)) that bear little to no relation to the RCA model. Feature selection may be automated, semi-automated or manual. For example, RCA model training or an analysis may indicate which features in a data set are useful to predict root cause in an analysis of a particular topic (e.g., delay). An algorithm may be applied to select features. Features may be removed (e.g., not selected), for example, based on granularity, high correlation (e.g., obviousness), and/or irrelevance. The granularity of features may indicate their utility in predicting root cause. For example, a feature may be too high-level or too low-level (e.g., too granular or too unique) to be of significant value in determining root cause. A feature with a high correlation level (e.g., too obvious) may (e.g., also) be removed (e.g., not selected) for RCA model features, for example, so that the RCA model provides useful (e.g., non-obvious) insight. In an example, if age is used as a feature and there is only one case among 1,000 cases for a 25-year old, age may be too granular. Features may be customized manually, semi-automatically or automatically (e.g., by a user of an RCA model), for example, to provide customizable insights based on business knowledge.

At step 214, one or more RCA rules may be generated (e.g., by rule generator 134) based on the selected features and label(s). RCA rules may be generated by an RCA engine, which may be or may include a machine learning (ML) model. Rule generation 214 may be based on (e.g., may promote) visualization of rules, e.g., to show the impact of features on the target, which form the basis of rules. RCA generation 214 may be based on, for example, a Shapley technique, subgroup discovery, uplifting trees, etc., alone or in combination. A Shapley value may be computed by making changes in input features to determine how the changes to the input features correspond to a model prediction. A Shapley value of a feature may be calculated as an average marginal contribution to the overall model score. An RCA rule may indicate, for example, that there is a delay in 85% of cases where middle-aged customers visit on weekends. In some examples, there may be multiple rules, such as a sequence of rules.

At step 216, one or more RCA rules may be selected (e.g., by rule generator 134) from the generated rule(s). Rules may be based on one or more features (e.g., N-gram). Rule selection 216 may select rules for visualization based on one or more thresholds indicating a threshold impact in order to be visualized.

At step 218, one or more selected RCA rules may be visualized (e.g., by visualizer 138) for client 202. Visualization 218 may visualize relationships between rules and features (e.g., target feature(s)). Visualization 218 may show an impact of one or more (e.g., a combination of) features. Visualization 218 may visualize a rule, such as, for example, there is a delay for cases that arrive on a Monday, summer month, when the number of active cases is high. In simple examples of visualization for online shopping by customers, visualization may show one or more rules indicating that: (i) if a customer buys one item from an online store, delivery may occur sooner than an order of ten different items and (ii) if a customer orders on a Saturday, delivery may take longer. Visualization 218 may visualize rules using graphics, natural language processing (NLP), etc. Visualization 218 may convert the findings of a rule to an appropriate (e.g., the most appropriate) visualization, whether text, graphics (plot, chart, table), etc., or a combination thereof

Visualizer 138 may (e.g., be configured to) analyze and/or present alternative (e.g., hypothetical, what-if, potential or modified) scenarios, for example, to provide user(s) 102 with options to improve process performance. Visualizer 138 may propose hypothetical scenarios and/or may evaluate potential improvements in process performance based on RCA rules generated by Rule generator 134. User(s) 102 may be presented (e.g., in a GUI provided by RCA client 106) with alternative (e.g., hypothetical, what-if, potential or modified) scenarios for prospective process implementation. Potential opportunities to reduce delays may be identified, for example, by limiting reliance on public resources, scheduling on faster (e.g., newer generations of) machines, improving load balancing across machines, modifying a process plan, etc. Visualizer 138 may generate process improvement information, which may include, for example, possible changes to a process, based on actual and/or prospective RCA rules generated by Rule generator 134. Process improvement information may be provided by visualizer 138 to manager 126 to RCA client 106 and/or to storage server(s) 114 to store as visualizations 122. Visualizations 122 may be provided to client 106 for presentation (e.g., display) to user(s) 102 on a GUI displayed by computing device(s) 104. A presentation may include, for example, displaying process improvement information to user(s) 102.

FIG. 3 shows an example of a visualization 300 of conditions (e.g., subgroups), according to embodiments. Visualization 300 is an example of one of visualizations 122, and may show (e.g., in a chart) different actions and how they change the possibility of achieving a label value. Visualization 300 may be interactive. For example, user(s) 102 may select a condition. Visualizer 138 may respond to selection of a condition by showing possible actions for the selected condition and the impacts of the actions on the label value.

As shown by example in FIG. 3, conditions include priority, resulting in better performance (e.g., less delay in process), location equal to Europe and submission during the summer months, resulting in poorer performance, less than two items, resulting in better performance, customer age under 30 years old, resulting in improved performance, etc.

FIG. 4 shows a visualization 400 of actions discovered (e.g., and selected) for a condition, according to embodiments. Visualization 400 is an example of visualizations 122 of FIG. 1 and illustrates an example of how actions impact a selected condition. The values of process-based features may be changed. Showing actions may assist user(s) 102 with insights to understand the cause(s) of different label values and/or to improve a process based on the insights.

As shown by example in FIG. 4, the selected condition is less than two items (e.g., Number of items<2). FIG. 4 shows the impact of actions taken with the selected condition. The actions based on the condition include, for example, involving resource X, resulting in better performance (e.g., less delay), executing activity “double check,” resulting in a poorer performance, having more than one payment, resulting in better performance, calling the customer, resulting in better performance, and sending an email, resulting in poorer performance.

A mined action may be additionally and/or alternatively visualized, for example, using a natural language processing (NLP) method. Insightful statements may be generated based on the discovered rules. An example of an NLP visualization may include, for example, “When there are less than two items in the order, involving resource X leads to slightly less delayed process instances (e.g., with an average impact of 0.045).”

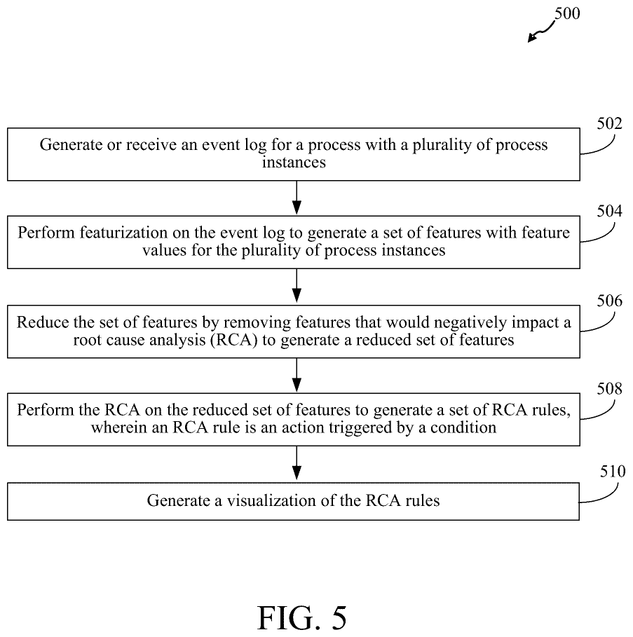

FIG. 5 shows a flowchart of a method 500 for performing root cause analysis in process mining, according to an example embodiment. Embodiments disclosed herein and other embodiments may operate in accordance with example method 500. Method 500 comprises steps 502-510. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implements all of the steps illustrated in FIG. 5. FIG. 5 is simply one of many possible embodiments. Embodiments may implement fewer, more or different steps.

As shown in FIG. 5, in step 502, an event log for a process with a plurality of process instances may be generated or received. For example, as shown in FIG. 1, RCA manager 126 may receive (e.g., from RCA client 106) an indication of process data 116 and/or event logs 118. RCA client 106 may generate event logs 118 from process data 116. Input generator 128 may generate event logs 118 from process data 116.

As shown in FIG. 5, in step 504, featurization may be performed on the event log to generate a set of features with feature values for the plurality of process instances. For example, as shown in FIG. 1, featurizer 130 may generate a set of features with feature values from event logs 118.

As shown in FIG. 5, in step 506, the set of features may be reduced by removing features that would negatively impact a root cause analysis (RCA) to generate a reduced set of features. For example, as shown in FIG. 1, feature selector 132 may reduce the set of features generated by featurizer 130 by selecting or excluding features based on at least one of a correlation threshold, a granularity threshold, or a relevance threshold (e.g., to remove features that would negatively impact the utility of RCA rules generated by the RCA).

As shown in FIG. 5, in step 508, the RCA may be performed on the reduced set of features to generate a set of RCA rules, where an RCA rule is an action triggered by a condition. For example, as shown in FIG. 1, rule generator 134 may generate a set of RCA rules 120 based on the reduced set of features generated by feature selector 132.

As shown in FIG. 5, in step 510, a visualization of the RCA rules may be generated. For example, as shown in FIGS. 1, 3 and 4, visualizer 138 may generate visualizations 122 for the RCA rules 120.

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

FIG. 6 shows an exemplary implementation of a computing device 600 in which example embodiments may be implemented. Consistent with all other descriptions provided herein, the description of computing device 600 is a non-limiting example for purposes of illustration. Example embodiments may be implemented in other types of computer systems, as would be known to persons skilled in the relevant art(s).

As shown in FIG. 6, computing device 600 includes one or more processors, referred to as processor circuit 602, a system memory 604, and a bus 606 that couples various system components including system memory 604 to processor circuit 602. Processor circuit 602 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 602 may execute program code stored in a computer readable medium, such as program code of operating system 630, application programs 632, other programs 634, etc. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random-access memory (RAM) 610. A basic input/output system 612 (BIOS) is stored in ROM 608.

Computing device 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 630, one or more application programs 632, other programs 634, and program data 636. Application programs 632 or other programs 634 may include, for example, computer program logic (e.g., computer program code or instructions) for implementing example embodiments described herein.

A user may enter commands and information into the computing device 600 through input devices such as keyboard 638 and pointing device 640. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 602 through a serial port interface 642 that is coupled to bus 606, but may be connected by other interfaces, such as a parallel port, game port, or a universal serial bus (USB).

A display screen 644 is also connected to bus 606 via an interface, such as a video adapter 646. Display screen 644 may be external to, or incorporated in computing device 600. Display screen 644 may display information, as well as being a user interface for receiving user commands and/or other information (e.g., by touch, finger gestures, virtual keyboard, etc.). In addition to display screen 644, computing device 600 may include other peripheral output devices (not shown) such as speakers and printers.

Computing device 600 is connected to a network 648 (e.g., the Internet) through an adaptor or network interface 650, a modem 652, or other means for establishing communications over the network. Modem 652, which may be internal or external, may be connected to bus 606 via serial port interface 642, as shown in FIG. 6, or may be connected to bus 606 using another interface type, including a parallel interface.

As used herein, the terms “computer program medium,” “computer-readable medium,” and “computer-readable storage medium” are used to refer to physical hardware media such as the hard disk associated with hard disk drive 614, removable magnetic disk 618, removable optical disk 622, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media that are separate and non-overlapping with embodiments directed to computer-readable storage media.

As noted above, computer programs and modules (including application programs 632 and other programs 634) may be stored on the hard disk, magnetic disk, optical disk, ROM, RAM, or other hardware storage medium. Such computer programs may also be received via network interface 650, serial port interface 642, or any other interface type. Such computer programs, when executed or loaded by an application, enable computing device 600 to implement features of example embodiments described herein. Accordingly, such computer programs represent controllers of the computing device 600.

Example embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Example Embodiments

Methods, systems and computer program products are provided for performing root cause analysis in process mining. Root causes of labeled values may be determined and visualized for user interpretation. The performance of root cause analysis (RCA) may be improved, for example, by selecting and/or excluding features based on at least one of correlation, granularity, and/or relevance thresholds. An RCA engine may perform RCA on a set of features to generate a set of RCA rules (e.g., actions triggered by conditions). A visualizer may generate a visualization of the RCA rules. Visualizations may be interactive. For example, users may select a condition to view actions triggered by the condition. Rules may be developed by modifying feature values (e.g., using LIME, SHAP). Users may provide target goals to improve a process, for example, before and/or after visualization. The RCA engine may perform an RCA based on modified feature values to achieve the target goal and present (e.g., visualize) target modifications.

In examples, a computing system may comprise a processor; and a memory device that stores program code to be executed by the processor. The program code may comprise a featurizer that performs featurization on an event log for a process with a plurality of process instances to generate a set of features with feature values for the plurality of process instances. The set of features may exclude features that would negatively impact a root cause analysis (RCA). For example, the featurizer or a feature selector may select or exclude features based on at least one of a correlation threshold, a granularity threshold, or a relevance threshold. The program code may comprise an RCA engine that performs the RCA on the set of features to generate a set of RCA rules, wherein an RCA rule is an action triggered by a condition. The program code may comprise a visualizer that generates a visualization of the RCA rules.

In examples, the featurizer may comprise a feature selector that reduces the set of generated features by removing the features that would negatively impact the RCA.

In examples, the visualization of the RCA rules may be an interactive visualization.

In examples, the interactive visualization may present a selectable condition in the set of RCA rules, and at least one action when the selectable condition is selected.

In examples, the computing system may (e.g., further) comprise an RCA manager that receives an indication of a target goal to improve the process. The RCA engine may be that performs the RCA on the reduced set of features with modified feature values to achieve the target goal.

In examples, the RCA engine determines each condition based on at least one instance-based feature and to determine each action based on at least one process-based feature.

In examples, the RCA engine determines a plurality of conditions in the set of RCA rules using subgroup discovery and/or to select conditions from among the plurality of conditions based on a threshold level of occurrence among the plurality of process instances.

In examples, the RCA engine determines a plurality of actions in the set of RCA rules by varying at least one of the feature values for at least one feature in the reduced set of features (e.g., using LIME, SHAP). The RCA engine selects actions from among the plurality of actions based on at least one threshold level of impact on a value or class of an evaluated or labeled feature.

In examples, a computing system of claim may (e.g., further) comprise, a rule selector reduces the set of RCA rules based on at least one RCA rule threshold, wherein the visualizer generates a visualization of the reduced set of RCA rules.

In examples, a method may comprise generating or receiving an event log for a process with a plurality of process instances; performing featurization on the event log to generate a set of features with feature values for the plurality of process instances; reducing the set of features by removing features that would negatively impact a root cause analysis (RCA) to generate a reduced set of features; performing the RCA on the reduced set of features to generate a set of RCA rules, wherein an RCA rule is an action triggered by a condition; and generating a visualization of the RCA rules.

In examples, the visualization may be an interactive visualization presenting a selectable condition in the set of RCA rules, and at least one action when the selectable condition is selected.

In examples, a method may (e.g., further) comprise: receiving, e.g., based on the visualization, an indication of a target goal to improve the process; and performing the RCA on the reduced set of features with modified feature values to achieve the target goal.

In examples, each condition may be determined based on at least one instance-based feature and each action is determined based on at least one process-based feature.

In examples, a method may (e.g., further) comprise: determining a plurality of conditions in the set of RCA rules; and selecting conditions from among the plurality of conditions based on a threshold level of occurrence among the plurality of process instances

In examples, a method may (e.g., further) comprise: determining a plurality of actions in the set of RCA rules by varying at least one of the feature values for at least one feature in the reduced set of features [e.g., using LIME, SHAP]; and selecting actions from among the plurality of actions based on at least one threshold level of impact on a value or class of an evaluated or labeled feature.

In examples, a method may (e.g., further) comprise: reducing the set of RCA rules based on at least one RCA rule threshold; and generating a visualization of the reduced set of RCA rules.

In examples, a computer-readable storage medium may have program instructions recorded thereon that, when executed by a processing circuit, perform a method comprising: performing featurization on an event log for a process with a plurality of process instances to generate a set of features with feature values for the plurality of process instances, wherein the set of features selects or excludes features based on at least one of a correlation threshold, a granularity threshold, or a relevance threshold; performing a root cause analysis (RCA) on the set of features to generate a set of RCA rules, wherein an RCA rule is an action triggered by a condition; and generating a visualization of the RCA rules.

In examples, a method implemented by execution of executable instructions may (e.g., further) comprise: receiving, based on the visualization, an indication of a target goal to improve the process; performing the RCA on the set of features with modified feature values to achieve the target goal; and generating a modified visualization of the RCA rules.

In examples, a method implemented by execution of executable instructions may (e.g., further) comprise: determining a plurality of conditions in the set of RCA rules; and selecting conditions from among the plurality of conditions based on a threshold level of occurrence among the plurality of process instances; determining a plurality of actions in the set of RCA rules by varying at least one of the feature values for at least one feature in the reduced set of features [e.g., using LIME, SHAP]; and selecting actions from among the plurality of actions based on at least one threshold level of impact on a value or class of an evaluated or labeled feature.

In examples, a method implemented by execution of executable instructions may (e.g., further) comprise: reducing the set of RCA rules based on at least one RCA rule threshold; and generating a visualization of the reduced set of RCA rules.

### V. Conclusion

While various examples have been described above, it should be understood that they have been presented by way of example only, and not limitation. It will be understood by those skilled in the relevant art(s) that various changes in form and details may be made therein without departing from the spirit and scope of the present subject matter as defined in the appended claims. Accordingly, the breadth and scope of the present subject matter should not be limited by any of the above-described examples, but should be defined only in accordance with the following claims and their equivalents.

What is claimed is:

1. A computing system, comprising:
a processor; and
a memory device that stores program code to be executed by the processor, the program code comprising:
a featurizer that performs featurization on an event log for a process with a plurality of process instances to generate a set of features with feature values for the plurality of process instances, wherein the set of features excludes features that would negatively impact a root cause analysis (RCA);
an RCA engine that performs the RCA on the set of features to generate a set of RCA rules, wherein an RCA rule is an action triggered by a condition; and
a visualizer that generates a visualization of the RCA rules.

2. The computing system of claim 1, wherein the featurizer comprises a feature selector that reduces the set of generated features by removing the features that would negatively impact the RCA.

3. The computing system of claim 1, wherein the visualization of the RCA rules is an interactive visualization.

4. The computing system of claim 3, wherein the interactive visualization presents a selectable condition in the set of RCA rules, and at least one action when the selectable condition is selected.

5. The computing system of claim 1, further comprising:
an RCA manager that receives an indication of a target goal to improve the process, wherein the RCA engine performs the RCA on the reduced set of features with modified feature values to achieve the target goal.

6. The computing system of claim 1, wherein the RCA engine determines each condition based on at least one instance-based feature and to determine each action based on at least one process-based feature.

7. The computing system of claim 1, wherein the RCA engine determines a plurality of conditions in the set of RCA rules using subgroup discovery and to select conditions from among the plurality of conditions based on a threshold level of occurrence among the plurality of process instances.

8. The computing system of claim 1, wherein the RCA engine determines a plurality of actions in the set of RCA rules by varying at least one of the feature values for at least one feature in the reduced set of features and to select actions from among the plurality of actions based on at least one threshold level of impact on a value or class of an evaluated or labeled feature.

9. The computing system of claim 1, further comprising:
a rule selector that reduces the set of RCA rules based on at least one RCA rule threshold, wherein the visualizer generates a visualization of the reduced set of RCA rules.

10. A method, comprising:
generating or receiving an event log for a process with a plurality of process instances;
performing featurization on the event log to generate a set of features with feature values for the plurality of process instances;
reducing the set of features by removing features that would negatively impact a root cause analysis (RCA) to generate a reduced set of features;
performing the RCA on the reduced set of features to generate a set of RCA rules, wherein an RCA rule is an action triggered by a condition; and
generating a visualization of the RCA rules.

11. The method of claim 10, wherein the visualization is an interactive visualization presenting a selectable condition in the set of RCA rules, and at least one action when the selectable condition is selected.

12. The method of claim 10, further comprising:
receiving, based on the visualization, an indication of a target goal to improve the process; and
performing the RCA on the reduced set of features with modified feature values to achieve the target goal.

13. The method of claim 10, wherein each conditions is determined based on at least one instance-based feature and each action is determined based on at least one process-based feature.

14. The method of claim 10, further comprising:
determining a plurality of conditions in the set of RCA rules; and
selecting conditions from among the plurality of conditions based on a threshold level of occurrence among the plurality of process instances

15. The method of claim 10, further comprising:
determining a plurality of actions in the set of RCA rules by varying at least one of the feature values for at least one feature in the reduced set of features; and
selecting actions from among the plurality of actions based on at least one threshold level of impact on a value or class of an evaluated or labeled feature.

16. The method of claim 10, further comprising:
reducing the set of RCA rules based on at least one RCA rule threshold; and
generating a visualization of the reduced set of RCA rules.

17. A computer-readable storage medium having program instructions recorded thereon that, when executed by a processing circuit, perform a method comprising:
performing featurization on an event log for a process with a plurality of process instances to generate a set of features with feature values for the plurality of process instances, wherein the set of features selects or excludes features based on at least one of a correlation threshold, a granularity threshold, or a relevance threshold;
performing a root cause analysis (RCA) on the set of features to generate a set of RCA rules, wherein an RCA rule is an action triggered by a condition; and
generating a visualization of the RCA rules.

18. The computer-readable storage medium of claim 17, the method further comprising:
receiving, based on the visualization, an indication of a target goal to improve the process;
performing the RCA on the set of features with modified feature values to achieve the target goal; and
generating a modified visualization of the RCA rules.

19. The computer-readable storage medium of claim 17, the method further comprising:
determining a plurality of conditions in the set of RCA rules; and
selecting conditions from among the plurality of conditions based on a threshold level of occurrence among the plurality of process instances;
determining a plurality of actions in the set of RCA rules by varying at least one of the feature values for at least one feature in the reduced set of features; and
selecting actions from among the plurality of actions based on at least one threshold level of impact on a value or class of an evaluated or labeled feature.

20. The computer-readable storage medium of claim 17, the method further comprising:
reducing the set of RCA rules based on at least one RCA rule threshold; and
generating a visualization of the reduced set of RCA rules.
